(19) United States
(12) Patent Application Publication
(10) Pub. No.: US 2011/0164192 A1
(43) Pub. Date: Jul. 7, 2011

(54) PROJECTOR AND METHOD OF CONTROLLING THE SAME

(75) Inventor: Takashi OZAWA, Shiojiri-shi (JP)

(73) Assignee: SEIKO EPSON CORPORATION, Tokyo (JP)

(21) Appl. No.: 12/978,894

(22) Filed: Dec. 27, 2010

(30) Foreign Application Priority Data
Jan. 7, 2010 (JP) 2010-001770

(51) Int. Cl. H04N 9/31

(52) U.S. Cl. 348/744; 348/E09.025

(57) ABSTRACT

A projector includes: an image projection unit that projects a projection image generated based on input image data onto a projection surface; a projection distance measurement unit that measures a projection distance from the projector to the projection surface; and an adjusting unit that adjusts the project ion image in accordance with the projection distance so that the projection image is projected onto the projection surface under a predetermined projection condition.

The entire disclosure of Japanese Patent Application No. 2010-001770, filed Jan. 7, 2010 is expressly incorporated by reference herein.

### BACKGROUND

1. Technical Field

The present invention relates to a projector and a method of controlling the projector capable of measuring a projection distance to a projection surface to adjust image data of a projection image so that the projection image is projected onto a projection surface under predetermined projection conditions in accordance with the projection distance.

2. Related Art

Projectors are used not only for the purpose of projecting pictures and videos on a screen but also for projecting templates such as a ruled line or a grid used when inputting characters on a whiteboard during an office meeting, for example.

For example, JP-A-2004-198858 discloses a projector capable of selectively projecting a desired template in accordance with user designation during a meeting or the like.

However, according to the projector disclosed in JP-A-2004-198858, when displaying a plurality of ruled lines, for example, the user needs to designate the space of the ruled lines in accordance with the size of the projection surface. Moreover, for an inexperienced user, it is difficult to select and display a desired template at once.

### SUMMARY

According to an aspect of the invention, there is provided a projector including; an image projection unit that projects a projection image generated based on input image data onto a projection surface; a projection distance measurement unit that measures a projection distance from the projector to the projection surface; and an adjusting unit that adjusts a projection range of the projection image in accordance with the projection distance so that the projection image is projected onto the projection surface under a predetermined projection condition.

According to the projector, it is possible to project the projection image under an appropriate projection condition corresponding to the projection distance to the projection surface.

In the projector, the adjusting unit may adjust the projection image so that a projection magnification of the projection image is constant even when the projection distance changes.

According to this configuration, even when the installed position of the projector is changed, for example, so that the projection distance to the projection surface changes, the projection image can be projected with the same projection magnification before and after changing the installed position.

In the projector, the adjusting unit may calculate a projection region of the image projection unit based on the projection distance and adjusts the projection image in accordance with the projection region.

According to this configuration, even when the area of the projection region changes, the projection image can be projected with the same projection magnification.

In the projector, the adjusting unit may adjust the projection image which includes a plurality of ruled lines in one or both of vertical and horizontal directions onto the image region so that the space of the ruled lines corresponds to a predetermined space even when the projection distance changes.

According to this configuration, even when the installed position of the projector is changed, for example, so that the projection distance to the projection surface changes, the space of the ruled lines or the size of the grid in the projection image before and after changing the installed position can be maintained as a setting condition.

In the projector, the adjusting unit may change the number of ruled lines included in the projection image so that the space of the ruled lines corresponds to the predetermined space.

According to this configuration, even when the size of the projection region changes, the space of the ruled lines or the size of the grid in the projection image can be maintained to be constant before and after changing the installed position.

The projector may further include a storage unit that stores a plurality of templates of the projection image, of which the projection ranges are different, and the adjusting unit may select a predetermined template from the plurality of templates stored in the storage unit and input the selected template to the image projection unit so that the projection magnification of the projection image is constant even when the projection distance changes.

According to this configuration, even when the installed position of the projector is changed, for example, so that the projection distance to the projection surface changes, by projecting an appropriate template in accordance with the projection distance, the space of the ruled lines or the size of the grid in the projection image can be maintained to be constant before and after changing the installed position.

In the projector, the storage unit may store a plurality of kinds of the templates including a plurality of ruled lines in one or both of vertical and horizontal directions, and the adjusting unit may calculate a projection region of the image projection unit based on the projection distance, select the template capable of projecting the ruled lines at a predetermined space from the templates stored in the storage unit in accordance with the projection region, and input the selected template to the image projection unit.

According to this configuration, even when the installed position of the projector is changed, for example, so that the projection distance to the projection surface changes, the space of the ruled lines or the size of the grid in the projection image can be maintained to be constant before and after changing the installed position.

### BRIEF DESCRIPTION OF THE DRAWINGS

The invention will be described with reference to the accompanying drawings, wherein like numbers reference like elements.

FIG. 1 is a schematic diagram of a projector according to an embodiment of the invention and a remote controller that controls the projector.

FIG. 2 is a functional block diagram of the projector and the remote controller.

FIG. 3 shows an example of a projection image displayed in a specific projection region (Y) of a projection surface (X) of a screen.

FIG. 4 shows an example of a projection image displayed in a projection region (Y′) that is changed from the projection region (Y).

FIG. 5 shows another example of a projection image displayed on the specific projection region (Y) of the projection surface (X) of the screen.

FIG. 6 shows another example of a projection image displayed in the projection region (Y′) that is changed from the projection region (Y).

FIG. 7 shows an example of an operation flow of the projection operation by the projector.

### DESCRIPTION OF EXEMPLARY EMBODIMENTS

An embodiment of the invention will be described in detail. It should be noted that the embodiment described below does not restrict disadvantageously the content of the invention recited in the scope of the claims and not all of the constructions described with reference to the following embodiments are necessary as solving means of the invention.

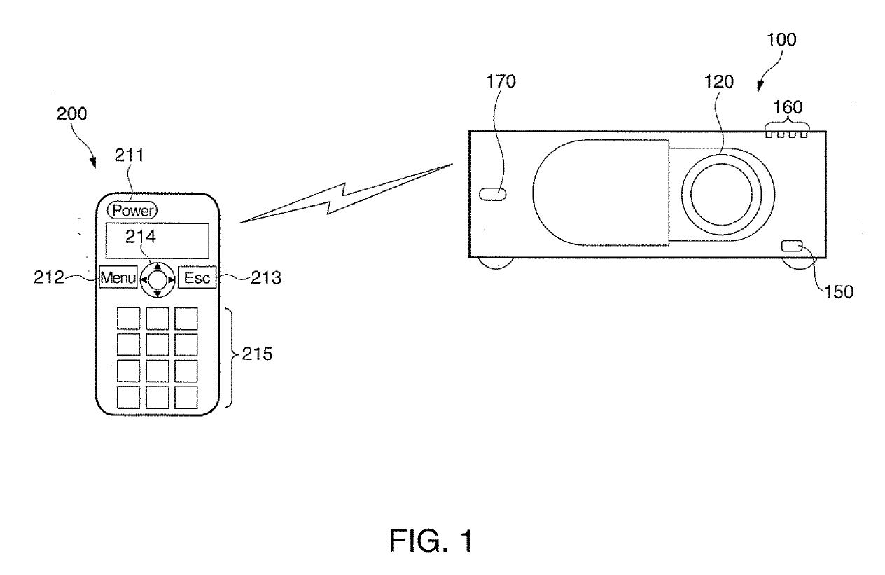

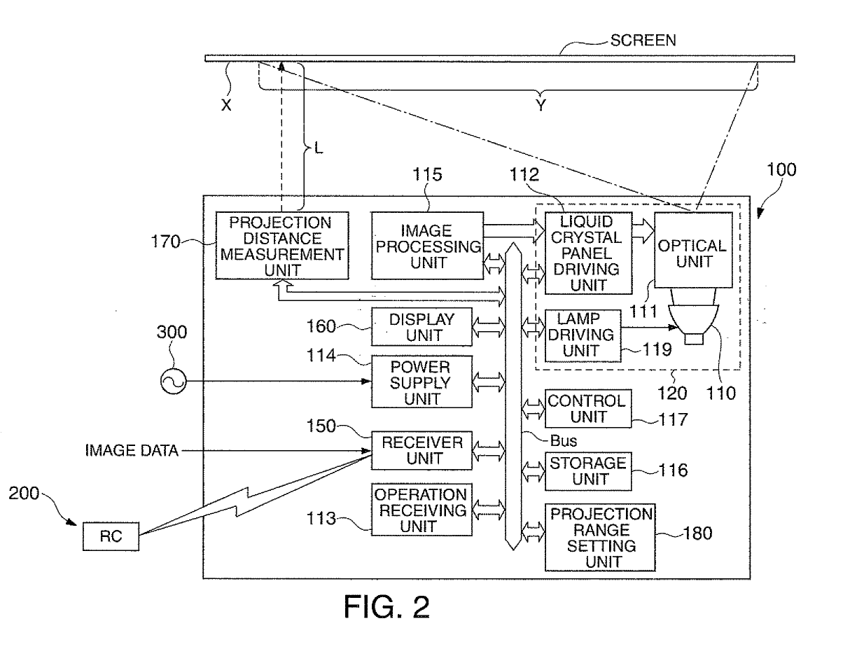

FIG. 1 is a schematic diagram of a projector 100 according to an embodiment of the invention and a remote controller 200 that controls the projector 100. FIG. 2 is a functional block diagram of the projector 100 and the remote controller 200. The projector 100 is a device capable of projecting a projection image generated based on image data which is input in a wireless or wired manner onto a projection surface such as a screen. The projector 100 is remote-controlled by a remote controller 200 (denoted as “RC” in FIG. 2) transmitting various operation signals in a wireless manner. The projector 100 is also controlled by an operation panel (not shown) of a main body.

The remote controller 200 is a wireless communication terminal having a size such that it can be carried by a user, for example. Various operation buttons including a power button 211, a menu button 212, an escape button 213, a scroll button 214, and a plurality of character/number input buttons 215 are arranged on the surface of a main body. In the remote controller 200, operation signals are generated based on the content of the operations which are input by a user pressing these operation buttons, and the operation signals are transmitted from a transmission unit (not shown) of the remote controller 200.

The projector 100 includes a lamp 110, an optical unit 111, a liquid crystal panel driving unit 112, an operation receiving unit 113, a power supply unit 114, an image processing unit 115, a storage unit 116, a control unit 117, a lamp driving unit 119, a receiver unit 150, a display unit 160, a projection distance measurement unit 170, and an adjusting unit 180. The projector 100 of this example is remote-controlled by an operation signal from the remote controller 200 so as to project a projection image generated based on image data, which is input externally or stored internally, onto a projection surface such as a screen.

The lamp 110 is a high-luminance discharge lamp such as a high-voltage mercury lamp, a metal-halide lamp, or a halogen lamp. The optical unit 111 includes an integrator optical system (not shown) that converts white light radiated by the lamp 110 into approximately parallel light of which the luminance distribution is stable, a separation optical system (not shown) that separates the white light having stable luminance distribution into light components of the colors of red, green, and blue and supplies the separated light components to liquid crystal light valves for the light of the respective colors, and a combining optical system (not shown) that recombines the light of the respective colors modulated by the liquid crystal light valves in accordance with the image signal for each color light.

The optical unit 111 generates projection light obtained by an internal projection lens enlarging the full-color and approximately parallel modulation light which is emitted from the combining optical system. In this way, the projector 100 is able to project a full-color video on a projection surface.

The liquid crystal panel driving unit 112 supplies a driving voltage or the like to the liquid crystal light valves (not shown) of the optical unit 111 together with the image signal input from the image processing unit 115 and outputs a projection image to the liquid crystal light valves.

The power supply unit 114 supplies power from an external power supply 300 to each unit of the projector 100 based on a signal from the control unit 117. More specifically, the power supply unit 114 converts AC power supplied from the external power supply 300 using an internal AC/DC conversion unit (not shown) and also supplies a stable DC voltage, that is rectified and smoothed, to each unit of the projector 100.

The lamp driving unit 119 includes an igniter circuit (not shown) that generates a high voltage for lighting the lamp 110 to form a discharge path and a balance circuit (not shown) for maintaining a stable lighting stage after the lighting. In the following description, the lamp 110, the optical unit 111, the liquid crystal driving unit 112, and the lamp driving unit 119 will be collectively referred to as an “image projection unit 120.”

The receiver unit 150 is a wireless LAN card compatible with at least any one of the wireless LAN specifications of IEEE 802.11a, IEEE 802.11b, and IEEE 802.11g, for example, an RFID tag, or a communication device compatible with the specifications of IrDA or Bluetooth (registered trademark). Moreover, the receiver unit 150 includes a USB terminal, a DV terminal, and the like, for example, and receives image data which are externally input.

The storage unit 116 stores various programs and associated data for controlling the operation of the projector 100 such as a startup routine at the time of starting up the projector 100. Moreover, the storage unit 116 stores a setting condition when the adjusting unit 180 sets a projection range of a projection image as described later and a projection condition that is set by a user or set in advance. Furthermore, the storage unit 116 may store image data supplied through the receiver unit 150 from the outside at the time of the projection operation. The storage unit 116 is configured by at least one of a nonvolatile memory such as a flash memory capable of storing data in a rewritable manner and a hard disk.

The image processing unit 115 generates an image signal to be projected onto a projection surface of a screen based on the externally input image data supplied through the receiver unit 150. More specifically, the image processing unit 115 reads out the image data stored in the storage unit 116 in units of frames, sequentially converts the image data into image signals, and outputs the image signals to the image projection unit 120.

The operation receiving unit 113 transmits a signal that triggers respective operations to the control unit 117 based on an operation content that is indicated by the operation signal received by the receiver unit 150. The control unit 117 controls each unit through a bus line Bus using the signal from the operation receiving unit 113 as a trigger.

The display unit 160 includes a LED that is lit in a plurality of colors, for example, and enables the user to be informed of the present state of the projector 100 in accordance with the lighting color of the LED and the lighting state (continuous lighting or blinking). For example, when the receiver unit 150 includes a plurality of image data input terminals, a specific image data input terminal is selected from these input terminals as a source terminal of a projection image, and image data is input to the selected source terminal, an LED (an input status LED) that indicates the input state of image data to the source terminal of the display unit 160 is lit green. On the other hand, when no image data is input to the source terminal, the input status LED is lit red. Moreover, when the input of the image data to the source terminal stops, the input status LED blinks red.

The display unit 160 is not limited to a form that has a LED as described above, but may be a small-size LCD (a liquid crystal display unit). Moreover, the content displayed by the display unit 160 is not limited to the state of the projector 100.

The projection distance measurement unit 170 includes a LED that emits light (infrared light) having a specific wavelength band in the infrared region and a light receiving element that receives the light in that wavelength region to output a voltage having a magnitude corresponding to the intensity of the received light, and measures a projection distance from the image projection unit 120 to a projection surface of a screen.

In this example, when measuring a projection distance to a projection surface, first, the projection distance measurement unit 170 radiates infrared light to the projection surface to detect the reception intensity of light reflected from the projection surface if the distance to the projection surface (a surface denoted by “X” on the screen of FIG. 2) is known. Moreover, the projection distance measurement unit 170 radiates infrared light to the projection surface of the screen at a predetermined timing to detect the reception intensity of light reflected by the projection surface and calculates the projection distance (a distance denoted by “L” in FIG. 2) to the projection surface through comparison with the reception intensity detected in advance. When the projector 100 is fixedly installed at a specific position such as a ceiling, the projection distance to the projection surface maybe measured by the projection distance measurement unit 170 after the installation and stored in the storage unit 116 or the like, and the stored measurement value may be used as the projection surface without performing the measurement again.

The projection distance measurement unit 170 may perform the projection distance measurement immediately after the projector 100 is started up and may perform the projection distance measurement in response to a predetermined operation of the user. Moreover, the projection distance measurement may be performed after the passage of a predetermined period from the start-up of the projector 100.

The adjusting unit 180 sets a projection range of a projection image in accordance with the projection distance measured by the projection distance measurement unit 170 so that the projection image is projected onto the projection surface under a predetermined projection condition. For example, the adjusting unit 180 sets the projection range of the projection image so that the projection magnification of the projection image is constant regardless of the projection distance. More specifically, the adjusting unit 180 calculates a projection region (a surface denoted by “Y” in the screen of FIG. 2) of the projection surface in which the projection image can be actually projected using any of the known methods at the timing at which the projection distance is measured by the projection distance measurement unit 170. In this example, it is assumed that the “projection region” refers to the area of a range of the projection surface in which image light is projected by the image projection unit 120.

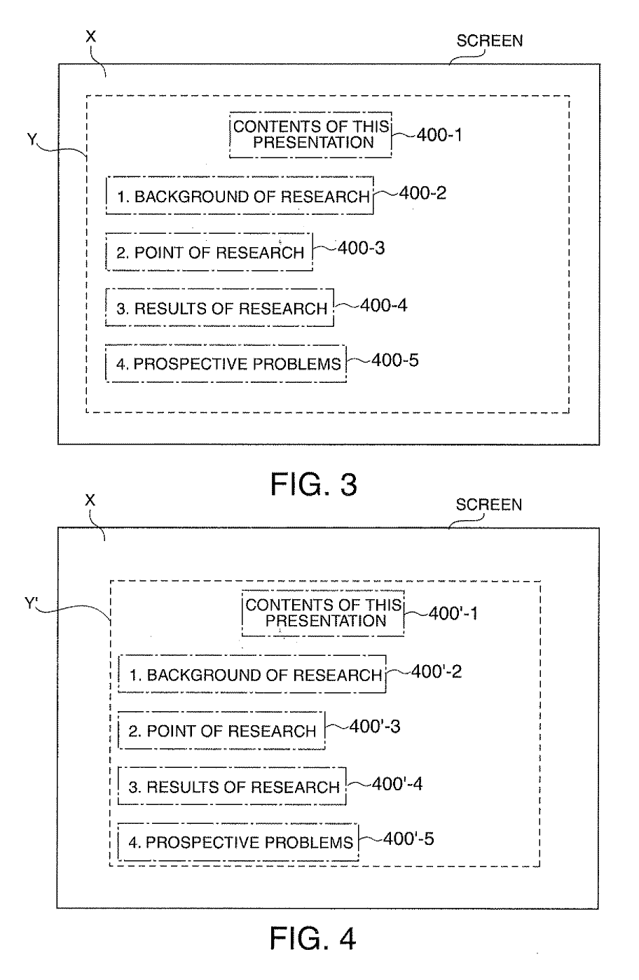

The adjusting unit 180 adjusts the image data which is input from the source terminal and stored in the storage unit 116 based on the predetermined condition in accordance with the projection region. For example, it is assumed that the projector 100 projects a projection image including objects 400-1, 400-2, . . . , and 400-5 made up of a character string onto a specific projection region (Y) in a projection surface (X) of the screen as shown in FIG. 3. Moreover, for example, when the installed position of the projector 100 or the screen is changed so that the same projection image is projected onto a projection region (Y′) smaller than the projection region (Y), the adjusting unit 180 changes the projection range of the projection image so that the projection image can be projected onto the new projection region (Y′).

More specifically, when two conditions “when the projection region is decreased, objects in the projection image are to be preferentially included in the changed projection region” and where “the projection magnification is not changed regardless of the projection region” are set in advance and stored in the storage unit 116, the adjusting unit 180 adjusts the image data so that the objects 400-1, 400-2, . . . , and 400-5 in the projection image projected onto the projection region (Y) are projected onto the new projection region (Y′) as objects 400′-1, 400′-2, . . . , and 400′-5 with the same size and positional relationship as shown in FIG. 4.

In this example, since the projection region (Y′) is smaller than the projection region (Y) and has a size (area) in which the objects 400-1, 400-2, and 400-5 can be projected without changing the positional relationship thereof, the adjusting unit 180 changes the projection range of the projection image projected onto the projection region (Y). That is, the adjusting unit 180 adjusts the image data so that the projection image projected onto the projection region (Y′) becomes an image in which the peripheral portion of the projection image projected onto the projection region (Y) is cut.

In this way, even when a projection region is changed, since the adjusting unit 180 sets the projection range of the projection image, the projector 100 is able to project the projection image having a predetermined projection condition onto the changed projection region.

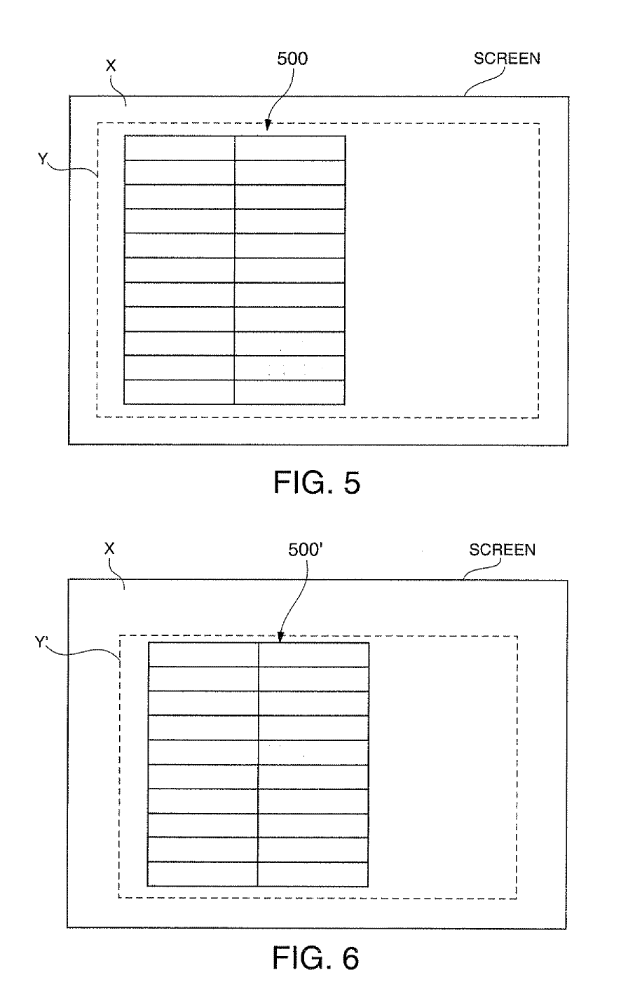

Moreover, when a projection image including a plurality of ruled lines in at least one of the vertical and horizontal directions projected onto a projection surface, the adjusting unit 180 adjusts the image data of the projection image so that the space of the ruled lines corresponds to a predetermined space regardless of the area of the projection region. For example, as shown in FIG. 5, it is assumed that a projection image including a grid object 500 including a plurality of ruled lines in the vertical and horizontal directions is projected onto a specific projection region (Y) in a projection surface (X) of the screen. Moreover, for example, when the installed position of the projector 100 or the screen is changed so that a projection image including the same grid object is selected and projected onto a projection region (Y′) smaller than the projection region (Y), the adjusting unit 180 adjusts the image data of the projection image based on a predetermined condition if it is unable to display the whole grid object 500 in the projection image projected onto the projection region (Y).

More specifically, for example, when a condition that “the grid object in a projection image is to be displayed as much as possible so that at least a number of rows that can be displayed in a projection region are to be displayed” is set in advance and stored in the storage unit 116, the adjusting unit 180 adjusts the image data so that a projection image including a grid object 500′ in which one row that does not fill the new projection region (Y′) is removed from the grid object 500 in the projection image projected onto the projection region (Y) is projected onto the new projection region (Y′) as shown in FIG. 6. That is, in this example, the adjusting unit 180 changes the number of ruled lines of the grid object included in the projection image by adjusting the imaging data of the projection image in accordance with the projection region.

The invention is not limited to a method in which the projection range setting 180 adjusts (processes) the image data of the projection image. For example, a plurality of kinds of templates of which the projection ranges for the same projection image are different may be stored in the storage unit 116 as image data, and the adjusting unit 180 may select a template appropriate for a projection condition and a projection region from the storage unit 116 and input the selected template to the image projection unit 120.

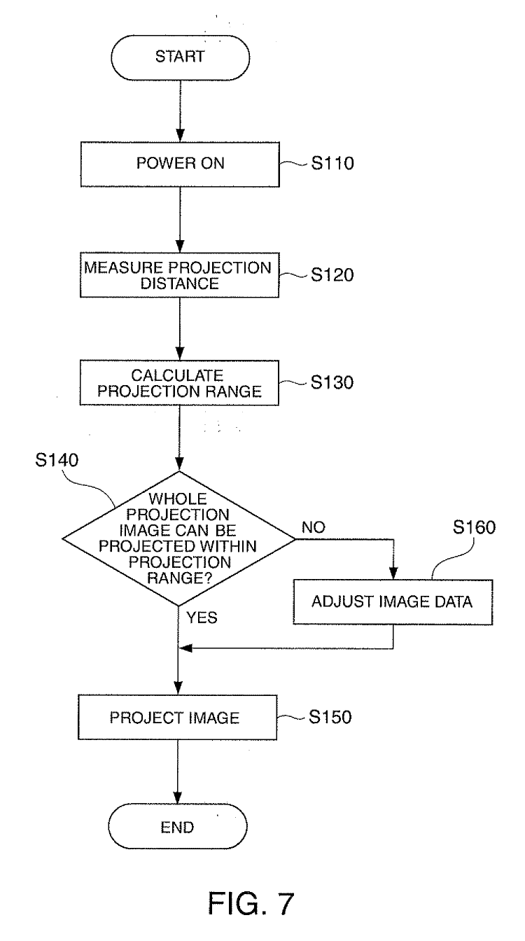

FIG. 7 shows an example of the operation flow of the projection operation of the projector 100. In this operation flow, first, a user starts up the projector 100 by pressing the power button 211 of the remote controller 200 or the power button (not shown) of the control panel of the main body (step S110) Then, the projection distance measurement unit 170 measures the projection distance from the image projection unit 120 to the projection surface of the screen (step S120).

The adjusting unit 180 calculates the projection region in the projection surface based on the measured projection distance (step S130). Here, when the whole projection image can be projected within the projection region while satisfying a predetermined projection condition (for example, a projection magnification or the like) (step S140: YES), the projection image is projected by the image projection unit 120 (step S150).

On the other hand, when it is not possible to project the whole projection image within the projection region while satisfying the projection condition (step S140: NO), the adjusting unit 180 adjusts the image data of the projection image stored in the storage unit 116 so that the projection range of the projection image has a size such that the projection image can be projected within the projection region (step S160). Moreover, the image processing unit 115 reads the adjusted image data out of the storage unit 116 and converts the image data into image signals. Thereafter, the image signals are projected as the projection image by the image projection unit 120 (step S150). In this way, the operation flow ends.

In the operation flow, although the projection distance measurement and the setting of the projection range of the projection image are performed when the projector 100 is powered on, the timing at which the projection distance measurement and the setting of the projection range of the projection image are performed is not limited to the time when the projector 100 is powered on. For example, such operations may be performed in response to a predetermined operation of the user during the projection operation of the projector 100.

As described above, the projector 100 according to the present embodiment is able to project a projection image under an appropriate projection condition in accordance with the projection distance to the projection surface. That is, for example, even when the installed position of the projector is changed so that the projection distance to the projection surface is changed, and as a result, the area of the projection region in the projection surface is changed, it is possible to project the projection image under an appropriate projection condition (for example, “the same projection magnification”) in accordance with the area of the projection region.

### Modification

In the embodiment described above, although a 3-plate type liquid crystal projector in which light from a light source is modulated by liquid crystal light valves which are light modulators and the modulated light is projected has been described, the invention can be applied to other types of projectors. Specifically, the invention can be applied to a projector using a so-called DLP (Digital Light Processing) (registered trademark) type which is a type using a DMD (Digital Micromirror Device). That is, the DLP type is a type in which white light emitted from a lamp is condensed by a lens to be incident on a DMD, and when individual mirrors of the DMD are switched to an ON state, light is enlarged by another lens and projected onto a screen. The invention is also applicable to a projector of such a type.

Moreover, in the embodiment described above, although a projector that projects an image using a discharge lamp as a light source has been described, the invention can be applied to a projector that projects an image using an LED light source, a laser light source, and the like as the light source.

What is claimed is:

1. A projector comprising:
an image project ion unit that projects a projection image generated based on input image data onto a projection surface;
a projection distance measurement unit that measures a projection distance from the projector to the projection surface; and
an adjusting unit that adjusts the projection image in accordance with the projection distance so that the projection image is projected onto the projection surface under a predetermined projection condition.

2. The projector according to claim 1, wherein the adjusting unit adjusts the projection image so that a projection magnification of the projection image is constant even when the projection distance changes.

3. The projector according to claim 2, wherein the adjusting unit calculates a projection region of the image projection unit based on the projection distance and adjusts the projection image in accordance with the projection region.

4. The projector according to claim 3, wherein the adjusting unit adjusts the projection image which includes a plurality of ruled lines in one or both of the vertical and horizontal directions onto the image region so that the space of the ruled lines corresponds to a predetermined space even when the projection distance changes.

5. The projector according to claim 4, wherein the adjusting unit changes the number of ruled lines included in the projection image so that the space of the ruled lines corresponds to the predetermined space.

6. The projector according to claim 1, further comprising a storage unit that stores a plurality of templates of the projection image, of which the projection ranges are different, wherein the adjusting unit selects a predetermined template from the plurality of templates stored in the storage unit and inputs the selected template to the image projection unit so that the projection magnification of the projection image is constant even when the projection distance changes.

7. The projector according to claim 6,
wherein the storage unit stores a plurality of kinds of the templates including a plurality of ruled lines in one or both of vertical and horizontal directions, and
wherein the adjusting unit calculates a projection region of the image projection unit based on the projection distance, selects the template capable of projecting the ruled lines at a predetermined space from the templates stored in the storage unit in accordance with the projection region, and inputs the selected template to the image projection unit.

8. A method of controlling a projector, comprising:
projecting a projection image generated based on input image data onto a projection surface using an image projection unit;
measuring a projection distance from the projector to the projection surface; and
adjusting the projection image in accordance with the projection distance so that the projection image is projected onto the projection surface under a predetermined projection condition.
